(19) United States
(12) Patent Application Publication
(10) Pub. No.: US 2006/0133881 A1
(43) Pub. Date: Jun. 22, 2006

(54) Mobile computing device form factor

(76) Inventors: Edward P. Osburn, Tigard, OR (US); Damion T. Searls, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/023,211

(22) Filed: Dec. 22, 2004

(51) Int. Cl. B41J 5/10

(52) U.S. Cl. 400/489

(57) ABSTRACT

A handheld computing device is disclosed. In one embodiment the handheld computing device comprises a display screen having a first side and a second side, the first side operable to display visual images, a control mechanism coupled to the second side of the display screen, the control mechanism operable to control a visual indicia on the display screen.

### FIELD OF THE INVENTION

The invention relates to the form factor of a mobile computing device. More specifically, the invention relates to the layout and placement of control mechanisms and keyboards on a mobile computing device.

### BACKGROUND OF THE INVENTION

Increasingly powerful and efficient processors and silicon processes are fast becoming available that enable the possibility for a fully-functional PC in a very small form-factor. The issue is that a sub-notebook style form factor does not fully enable ergonomic, on-the-go use. Even the smallest sub-notebook does not enable web-surfing or typing while walking, sitting in an airport lounge, sitting in a coffee shop, or any environment where table-top or lap-top computing is inconvenient.

Blackberry™ devices and personal digital assistant (PDA) cell phones are currently the leading edge technology in small form factor computing devices. Some of these devices have keyboards and touch-sensitive screens, but there is a limited number of choices for keyboard layouts as well as visual indicia (e.g., mouse pointer) control mechanism options and locations.

### BRIEF DESCRIPTION OF THE DRAWINGS

The present invention is illustrated by way of example and is not limited by the figures of the accompanying drawings, in which like references indicate similar elements, and in which:

FIG. 1A illustrates one embodiment of a form factor for an ultra-mobile computing device.

FIG. 1B illustrates another embodiment of a form factor for an ultra-mobile computing device form.

FIG. 1C illustrates one embodiment of the back side of the device.

FIG. 1D shows an embodiment of a user interacting with the back side of the device shown in FIG. 1C.

FIG. 1E illustrates another embodiment of the back side of the device.

FIG. 1F illustrates one embodiment of the device with joystick-like mechanism.

FIG. 1G illustrates one embodiment of the device with a touch pad mechanism.

FIG. 1H illustrates one embodiment of the device from a left side view.

FIG. 2A illustrates another embodiment of a form factor for an ultra-mobile computing device.

FIG. 2B illustrates one embodiment of the back side of the hinged device.

FIG. 2C illustrates one embodiment of a left side view of the hinged device in an open position.

FIG. 2D illustrates one embodiment of a left side view of the hinged device in a closed position.

FIG. 3A illustrates one embodiment of the device's keyboard.

FIG. 3B illustrates another embodiment of the device's keyboard.

FIG. 3C illustrates an embodiment of a curved keyboard for the device.

FIG. 4A illustrates one embodiment of a relief view of a flat keyboard coupled to the device.

FIG. 4B illustrates one embodiment of a relief view of a raised keyboard coupled to the device.

FIG. 4C illustrates another embodiment of a relief view of a raised keyboard coupled to the device.

FIG. 5 illustrates another embodiment of a curved keyboard for the device.

### DETAILED DESCRIPTION OF THE INVENTION

Embodiments of amobile computing device form factor are disclosed. In the following description, numerous specific details are set forth. However, it is understood that embodiments may be practiced without these specific details. In other instances, well-known elements, specifications, and protocols have not been discussed in detail in order to avoid obscuring the present invention.

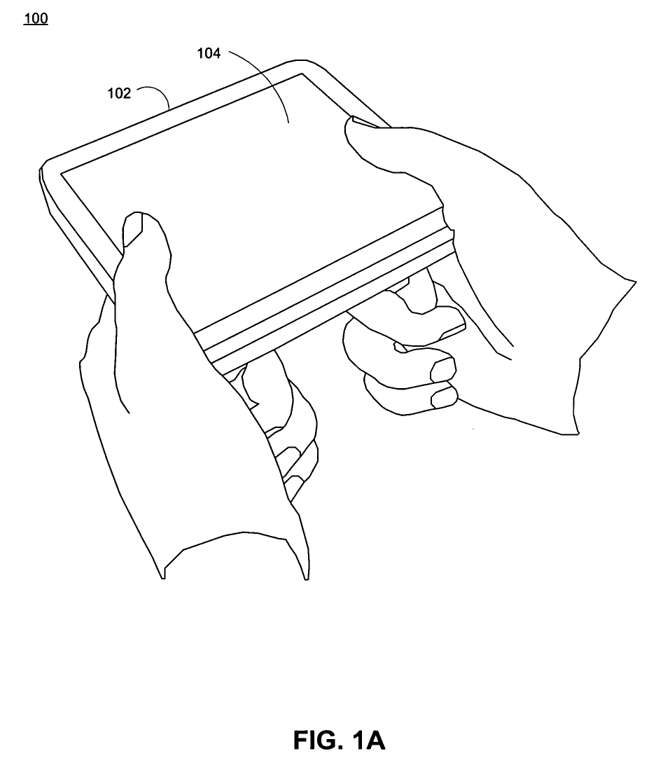

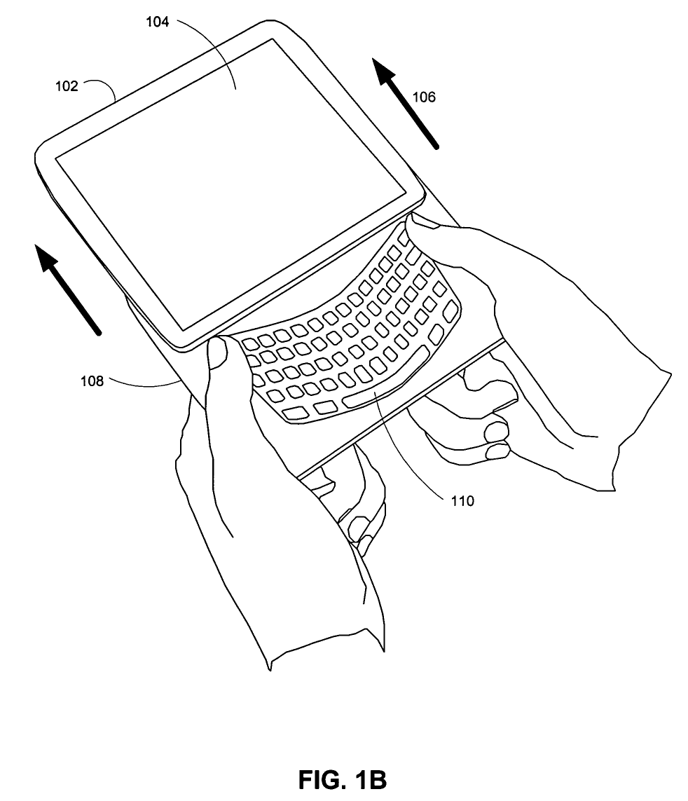

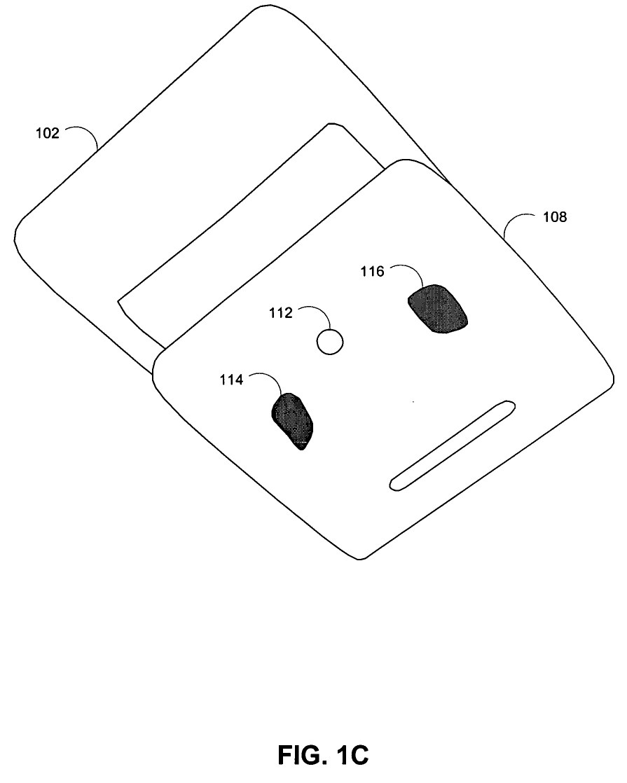

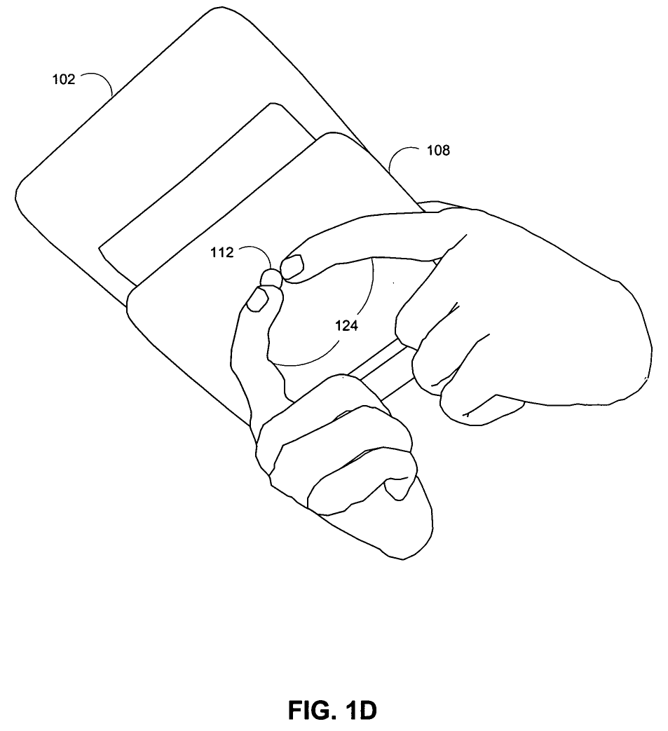

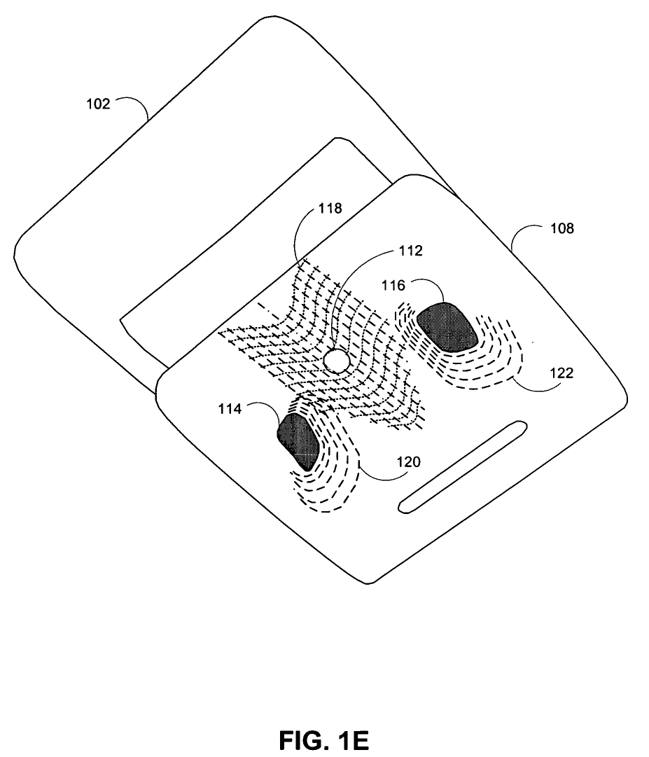

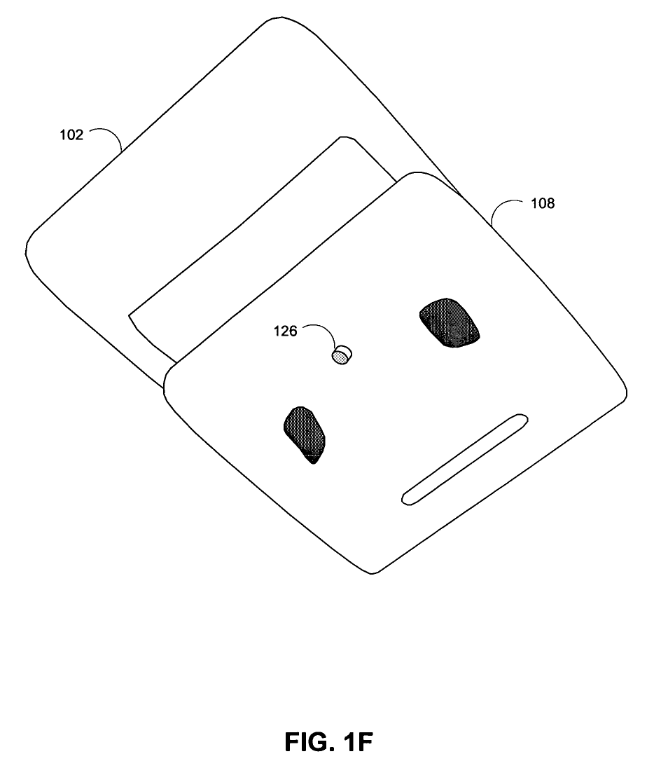

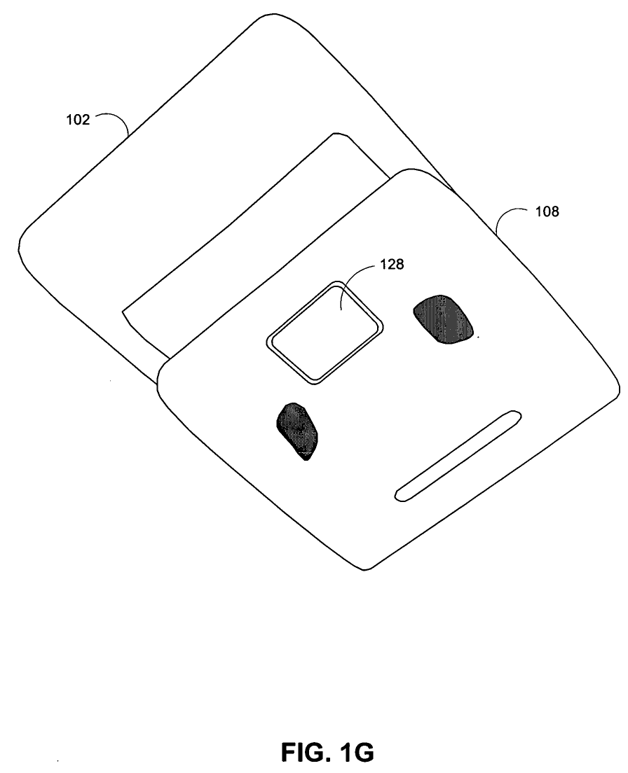

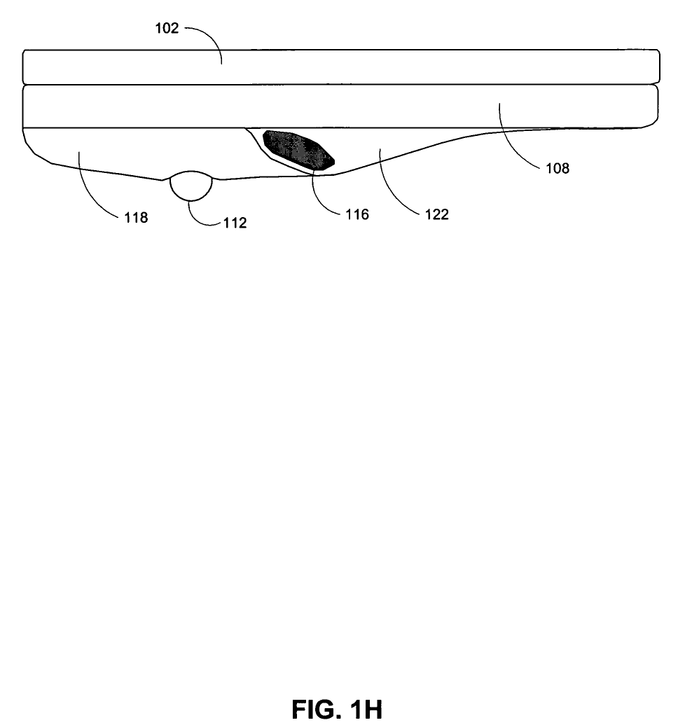

FIG. 1A illustrates one embodiment of a form factor for amobile computing device. In one embodiment, the device 100 includes a housing 102 and a display screen 104. In this embodiment, the housing 102 protects the reverse side of the display screen (the non-display side of the display screen). In another embodiment, the display screen 104 has a protective coating on the reverse side and there is no housing necessary. The display screen 104 may display any type of visual image or text. Although the device is held in two hands in FIG. 1A, in many embodiments, the device is capable of being completely operable while being held with only one hand.

FIG. 1B illustrates another embodiment of a form factor for amobile computing device. In this embodiment, the device includes a first housing 102 attached to a second housing 108. The first housing 102 houses the display screen 104 and the second housing 108 houses a keyboard 110. In this embodiment, the first housing 102 is attached to the second housing 108 via a sliding mechanism, which allows the first housing 102 to slide 106 up and down in a linear manner with respect to the second housing 108. In the closed position, the device resembles how the device appears in FIG. 1A. In the open position, the device resembles how the device appears in FIG. 1B. In the open position the keyboard 110 is visible, while it is not in the closed position. In one embodiment, the first housing 102 is permanently attached to the second housing 108, so although a limited amount of linear sliding 106 is allowed, the first housing 102 is not able to completely detach from the second housing 108. Additionally, FIG. 1B shows the user holding the device with two hands. In the position shown the keys on the keyboard are accessible to the user's thumbs. In this embodiment, the user cradles the device with his or her fingers and may use only both thumbs for typing on the keyboard (referred to as “thumb typing”).

In both FIGS. 1A and 1B the front side of the device is shown. FIG. 1C illustrates one embodiment of the back side of the device. The device is shown in the open position similar to the position in FIG. 1B. When in the open position, the back side of the first housing 102 is visible. In one embodiment, the back side of the second housing 108 includes a mechanism 112 to move a visual indicia (e.g., a pointer, cursor, etc.) on the display screen (FIG. 1B, 104). In one embodiment, the mechanism 112 is a trackball. In other embodiments, the mechanism 112 is a scroll wheel, a touchpad, or a joystick. In different embodiments, there may be one or more buttons located on the back side of the second housing 108. In the embodiment shown in FIG. 1C, there are two buttons (right button 114 and left button 116). The one or more buttons are included as standard input devices to assist the mechanism 112 in control of the visual indicia (e.g. similar to buttons on a personal computer mouse). The interaction required between the user and the buttons vary in different embodiments. In one embodiment, each button is mechanical and requires manual depression by a user for activation. In another embodiment, each button is a light sensor and requires an object to be moved in front of the button for activation. In yet another embodiment, each button is a capacitance-sensitive pad similar to touch pad and requires a user to touch the pad with a finger or other body part.

FIG. 1D shows an embodiment of a user interacting with the back side of the device shown in FIG. 1C. In this embodiment, the user manipulates the mechanism 112 with either his or her right or left index finger. The user's two index fingers 124 cover up the right and left buttons (114 and 116 in FIG. 1C). In different embodiments, the user may either squeeze or press his or her right or left index finger into the corresponding button for button activation.

FIG. 1E illustrates another embodiment of the back side of the device. In this embodiment, the backside of the device is shown in the open position similar to the position in FIG. 1B. Again, the back side of the second housing 108 includes a mechanism 112 and two buttons (right button 114 and left button 116) to control a visual indicia on the display screen. In this embodiment, the mechanism 112 is situated in the center of a rising center protrusion 118 in the back side of the second housing 108. In one embodiment, the center protrusion 118 creates relief off of the face of the back side of the second housing 108. The relief may help a user to easily access the mechanism 112 with his or her index finger. In this embodiment, the center protrusion 118 runs from the top center of the backside of the device down to the center of the back side of the device.

Additionally, the right and left buttons (114 and 116) are each situated on the side of two more rising protrusions (right protrusion 120 and left protrusion 122). In one embodiment, the right and left protrusions allow the user to wrap his or her right and left index fingers around the top side of the protrusions to allow for a molded trigger grip sensation for the index fingers. The trigger grip-type protrusions allow the user to firmly hold the device in one or both hands. Furthermore, the button locations on the top side of the protrusions allow the user to easily find the location of the buttons by way of feel when he or she is looking at the front side of the device. In this embodiment, the left and right protrusions (120 and 122) are located generally to the left and right respective sides of the center of the back side of the second housing 108. In one embodiment, the second housing 108 is formed from molded and hardened plastic to create the relief with the multiple protrusions.

FIG. 1F illustrates one embodiment of the device with joystick-like mechanism. Although a trackball is shown as an example of the mechanism described in FIG. 1C, there are many other types of mechanisms that would allow for controlling movement of the visual indicia on the display screen. In one embodiment, a joystick 126 is utilized to control the movement of the visual indicia. In one embodiment, the joystick 126 resembles a small cylinder that protrudes from the back side of the second housing 108. The cylinder has a rounded top and the user may manipulate the visual indicia by slightly pressing the cylinder in a given X-Y direction with the tip of one of his or her fingers (e.g., his or her left or right index finger). FIG. 1G illustrates one embodiment of the device with a touch pad mechanism. In one embodiment, the mechanism on the back side of the second housing 108 is a touch pad 128. The user may manipulate the visual indicia by touching the pad. In different embodiments, the touch pad may be a capacitance-sensitive pad, a pressure-sensitive pad, an optical pad, or any one of a number of other types of input pads.

In another embodiment, a scroll wheel may be utilized to control the scrolling movement of the screen or the visual indicia on the screen. In one embodiment, the scroll wheel may be implemented in place of another mechanism as described in FIGS. 1E through 1G. In another embodiment, the scroll wheel may be implemented in addition to another mechanism as described in FIGS. 1E through 1G.

FIG. 1H illustrates one embodiment of the device from a left side view. In this embodiment, the device is in the closed position so the first housing 102 is covering substantially the entire front side of the second housing 108. The side view also reveals a perspective of the device that shows the relief achieved from the back side of the second housing 108 with the center protrusion 118 and the left protrusion 122 (as fully described above in reference to FIG. 1E). In this left side view, the mechanism 112 (a trackball in this embodiment) is shown protruding out from the center protrusion 118, and the left button 116 is shown protruding out from the top side of the left protrusion 120 (in a trigger-like arrangement). Additionally, in one embodiment, the device may have one or more ports or connectors 130 to allow attachment to other devices. In different embodiments, the device may have a Universal Serial Bus port (USB), an IEEE 1394 “Firewire” port, or any one or more other ports or connectors built into the side of the device to allow for further I/O communication with other devices.

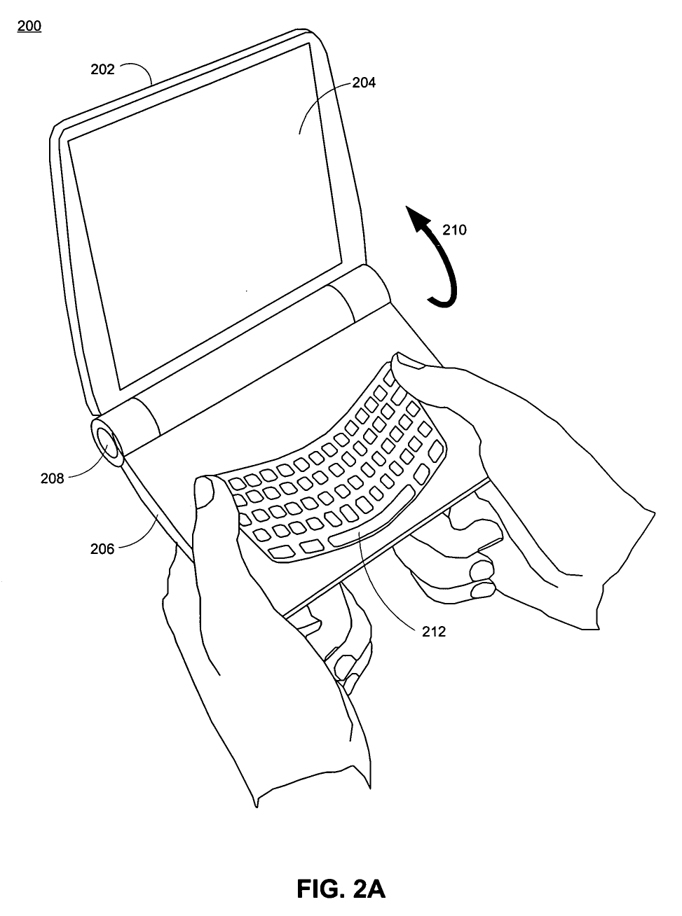

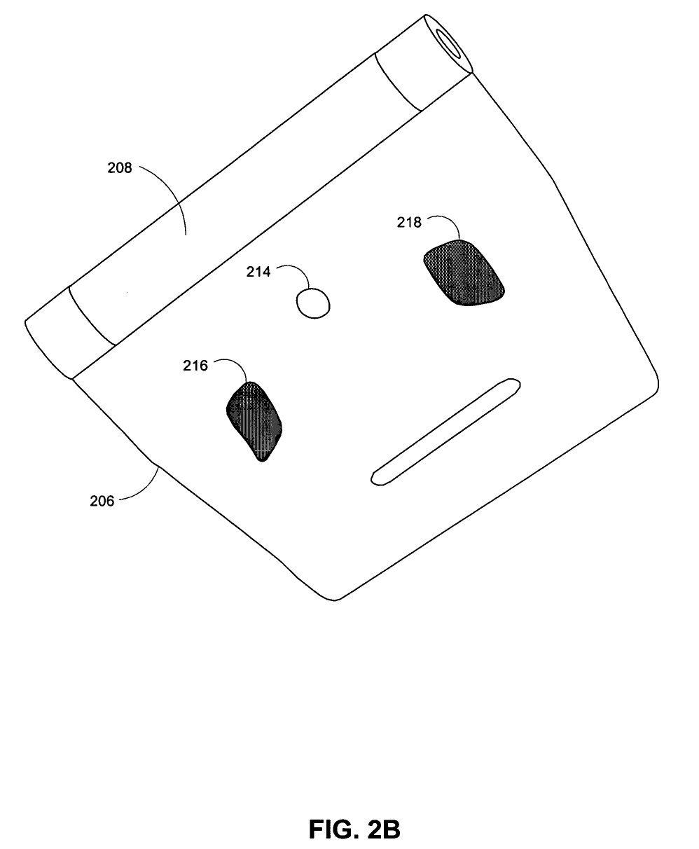

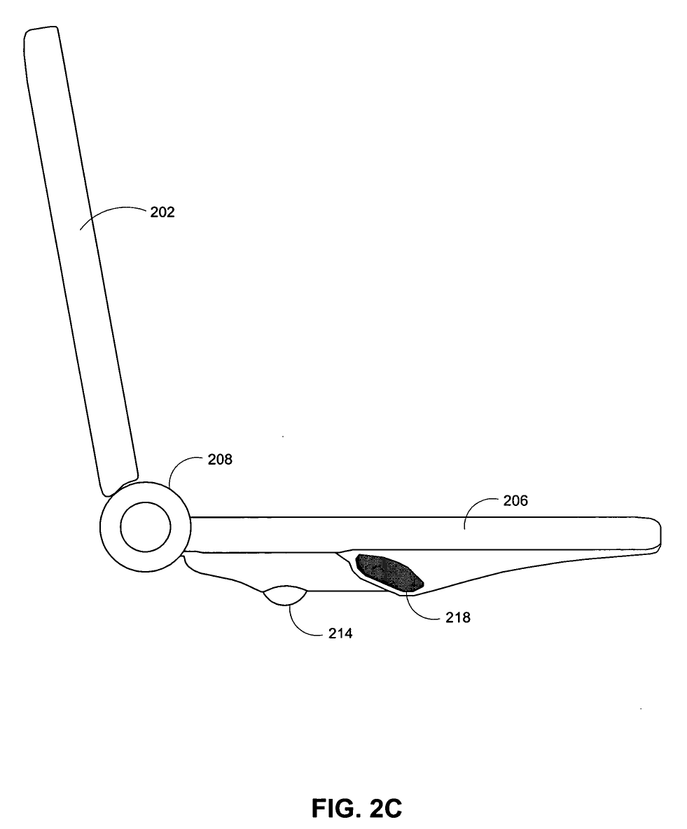

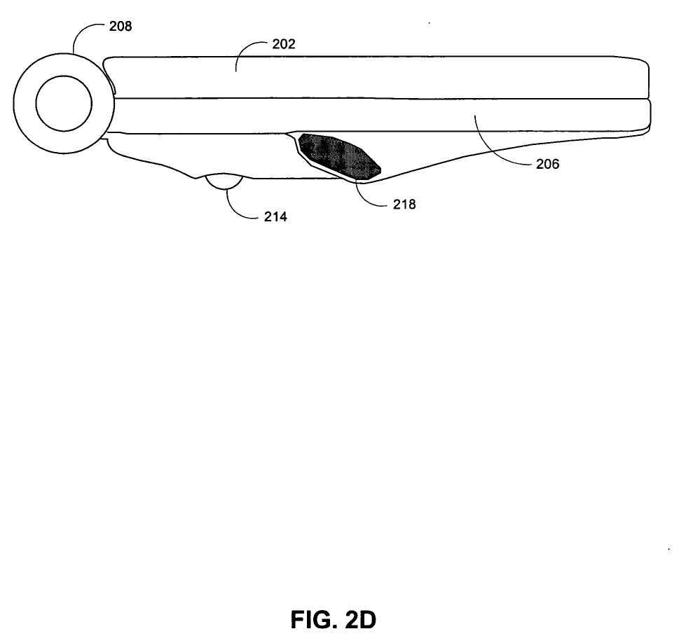

FIG. 2A illustrates another embodiment of a form factor for an ultra-mobile computing device. In this embodiment, the device includes a first housing 202 and a second housing 206. The first housing 202 is coupled to a display screen 204. The second housing 206 is coupled to a keyboard 212. In this embodiment, the first and second housings are coupled together by a hinge 208 that allows the two housings to pivot 210 open (with the display visible) or closed (with the display screen 204 closed down onto the keyboard 212 and second housing 206).

FIG. 2B illustrates one embodiment of the back side of the hinged device. In this embodiment, the back side of the second housing 206 includes a mechanism 214 to move a visual indicia (e.g., a pointer) on the display screen (FIG. 2A, 204). In different embodiments, the mechanism 214 may be a trackball, ajoystick, a touch pad, or any other effective mechanism designed to move the visual indicia on the display screen. In different embodiments, there may be one or more buttons located on the back side of the second housing 206. In the embodiment shown in FIG. 2B, there are two buttons (right button 216 and left button 218). The one or more buttons are included as standard input devices to assist the mechanism 214 in control of the visual indicia (e.g. similar to buttons on a personal computer mouse). In different embodiments, each button may be operable based on pressure, light, capacitance, or any other method to sense user input by interaction with a user's finger or other body part.

The first and second housings may be in at least a closed or open position. FIG. 2C illustrates one embodiment of a left side view of the hinged device in an open position. In this embodiment, the first housing 202 has been pivoted away from the second housing 206 using the hinge 208. The back side of the second housing 206 is shown with a center and left protrusion (similar to the center and left protrusions described in FIG. 1E). The mechanism 214 and the left button 218, both of which control the visual indicia on the display screen, are shown situated on the center and left protrusions respectively.

FIG. 2D illustrates one embodiment of a left side view of the hinged device in a closed position. In this embodiment, the first housing 202 has been closed onto the second housing 206 using the hinge 208. Again, the back side of the second housing 206 is shown with a center and left protrusion (similar to the center and left protrusions described in FIG. 1E). The mechanism 214 and the left button 218, both of which control the visual indicia on the display screen, are shown situated on the center and left protrusions respectively.

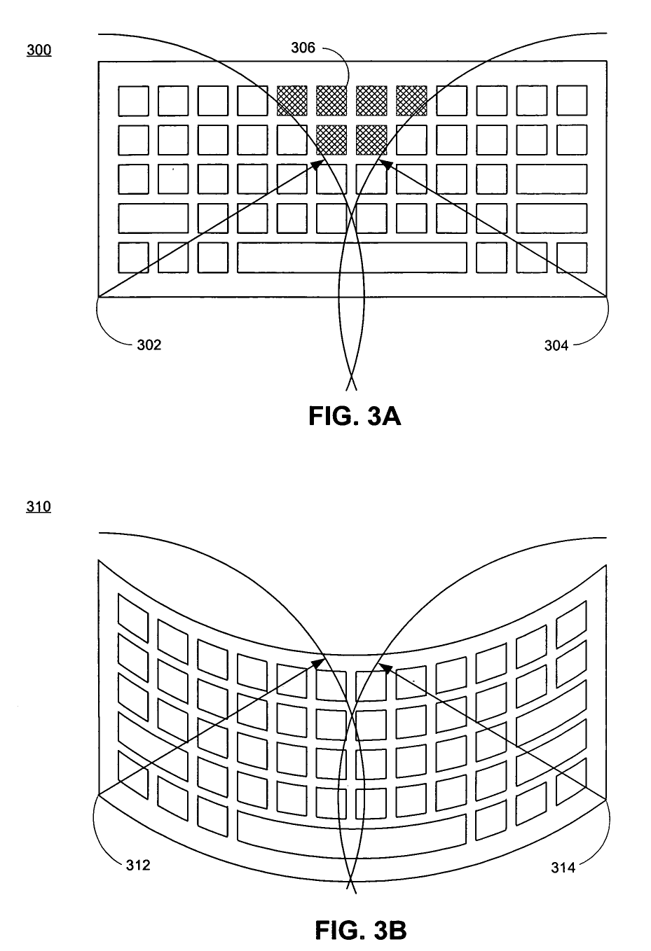

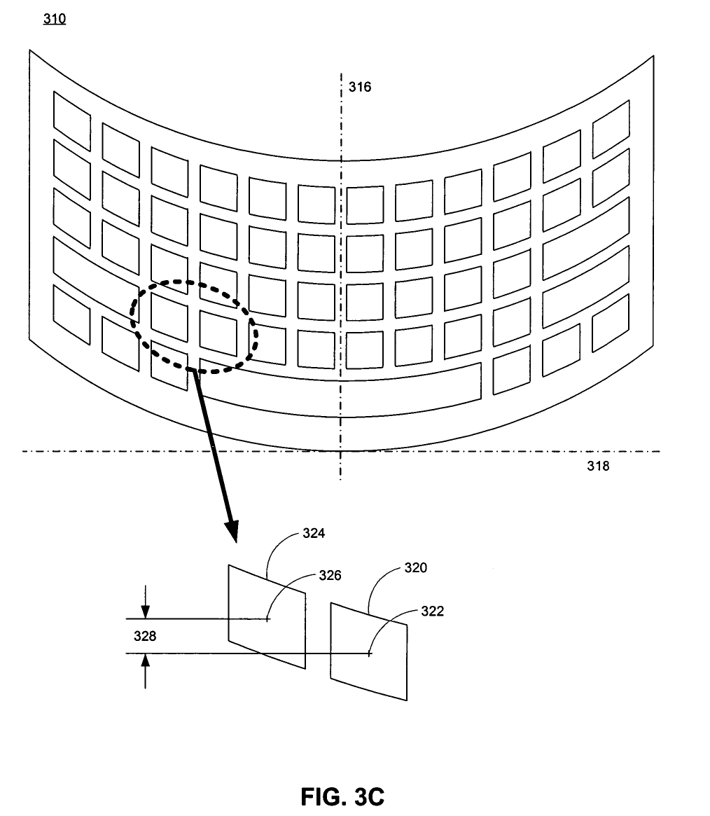

FIG. 3A illustrates one embodiment of the device's keyboard. In this embodiment, the keyboard 300 is a standard rectangular keyboard. In many embodiments, the keyboard is frequently utilized as a thumb typing keyboard because of the ultra-mobile small form factor (as seen in FIGS. 1B and 2A). Thus, in one embodiment, a user places the base joints of his or her thumbs (the joints that attaches each thumb to each respective hand) at the bottom left and right corner of the keyboard (302 and 304). Based on the length of a given user's thumbs, there is only a certain radius length of reachable keys if the user pivots his or her thumbs at the bottom left and right corners of the keyboard (302 and 304). It may be difficult for certain users to reach some of the top center keys 306 of the standard rectangular keyboard without moving each thumb's base joint toward the center of the keyboard 300. A curved keyboard may eliminate this thumb typing reach problem.

FIG. 3B illustrates another embodiment of the device's keyboard. In this embodiment, the keyboard 310 is a curved keyboard. A user may place the base joints of his or her thumbs (the joints that attaches each thumb to each respective hand) at the bottom left and right corner of the keyboard (312 and 314). In this embodiment, the same thumb typing coverage radius length as in FIG. 3A will provide adequate thumb coverage for all keys.

FIG. 3C illustrates an embodiment of a curved keyboard for the device. This embodiment illustrates a more detailed version of the layout of individual keys on the curved keyboard 310. In the discussion of individual keys, the location of any given key is that of its center. In one embodiment, the keyboard has a hypothetical center line 316 that splits the left and right sides of the keyboard. The bottom of the keyboard is comprised of a curved arc. A hypothetical tangent line 318 intersects the center of the arc at the location where the center line 316 intersects the arc as well. In one embodiment, the center line 316 intersects a row of keys between two keys (as shown in FIG. 3C). In this embodiment, the key immediately to the left of the center line and the key immediately to the right of the centerline are located the shortest distance from the tangent line 318 in comparison to any other keys in the same row. In another embodiment, the center line 316 intersects a row of keys within a single key instead of between two keys.

All keys in a row right of a given key that is right of the center line are located a greater distance from the tangent line than the given key. Similarly, all keys in a row left of a given key that is left of the center line are located a greater distance from the tangent line than the given key. For example, key 320 is located to the left of the center line 316 and key 324 is located to the left of key 320. Thus, in this embodiment, the center (326) of key 324 is located a greater distance from the tangent line than the center (322) of key 320 by a specific difference 328. In this embodiment, the specific difference between two adjacent keys is greater the further the two keys are from the center line. In general, depending on the location in the row of the two adjacent keys, the specific difference 328 between the two adjacent keys may be between 1.0 millimeters-1.0 centimeters.

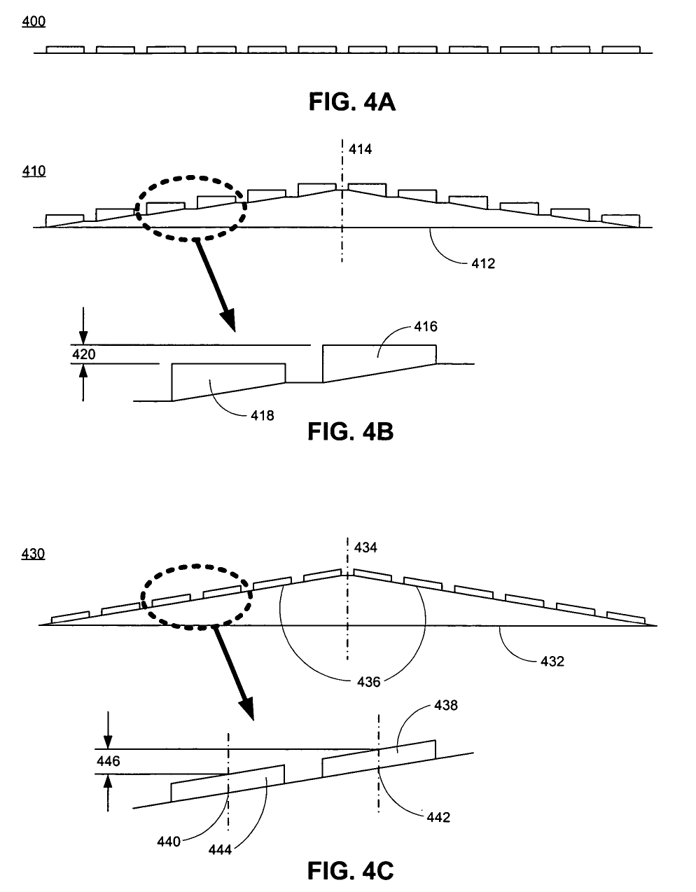

FIG. 4A illustrates one embodiment of a relief view of a flat keyboard coupled to the device. In this embodiment, all of the keys on the keyboard 400 are a uniform amount of relief off of the surface of the front side of the second housing (as shown in FIG. 2A, 206).

FIG. 4B illustrates one embodiment of a relief view of a raised keyboard coupled to the device. In this embodiment, the keys at the center of the keyboard 410 have the greatest relief from a hypothetical flat surface 412 of the front side of the second housing (as shown in FIG. 2A, 206) and the keys at the left and right ends of each row have the least relief from the hypothetical flat surface 412. The hypothetical flat surface 412 comprises a plane that would be located between the left and right edges of the front side of the second housing. In one embodiment, the keyboard has a hypothetical center line 414 that splits the left and right sides of the keyboard. In one embodiment, the center line 414 intersects a row of keys between two keys (as shown in FIG. 4B). In this embodiment, the key immediately to the left of the center line and the key immediately to the right of the center line have the greatest relief distance from the hypothetical flat surface 412 in comparison to any other keys in the same row. In another embodiment, the center line 414 intersects a row of keys within a single key instead of between two keys.

All keys in a row right of a given key that is right of the center line 414 have a relief distance from the hypothetical flat surface 412 less than the given key. Similarly, all keys in a row left of a given key that is left of the center line have a relief distance from the hypothetical flat surface 412 less than the given key. For example, key 416 is located to the left of the center line 414 and key 418 is located to the left of key 416. Thus, in this embodiment, key 416 is located a greater relief distance from the hypothetical flat surface 412 than key 418 by a specific difference 420. The specific difference 420 between the two adjacent keys may be between 0.5 millimeters-5.0 millimeters. In this embodiment, the surface of the keys that make up keyboard 410 are parallel to the hypothetical flat surface 412.

FIG. 4C illustrates another embodiment of a relief view of a raised keyboard coupled to the device. Again, in this embodiment, the keys at the center of the keyboard 430 have the greatest relief from a hypothetical flat surface 432 of the front side of the second housing and the keys at the left and right ends of each row have the least relief from the hypothetical flat surface 432. In this embodiment, the front side surface of the second housing protrudes off of the hypothetical flat surface 432. In one embodiment, the keyboard has a hypothetical center line 434 that splits the left and right sides of the keyboard. In one embodiment, the center line 434 intersects a row of keys between two keys (as shown in FIG. 4C). In this embodiment, the key immediately to the left of the center line and the key immediately to the right of the center line have the greatest relief distance from the hypothetical flat surface 432 in comparison to any other keys in the same row. In another embodiment, the center line 434 intersects a row of keys within a single key instead of between two keys.

The protruding surface 436 has the greatest relief distance from the hypothetical flat surface 432 at the center line 434. In this embodiment, the depressible surface of each key that makes up the keyboard is parallel to the underlying protruding surface.

All keys in a row right of a given key that is right of the center line 434 have a relief distance from the hypothetical flat surface 432 less than the given key. Similarly, all keys in a row left of a given key that is left of the center line have a relief distance from the hypothetical flat surface 432 less than the given key. For example, key 438 is located to the left of the center line 434 and key 440 is located to the left of key 438. Thus, in this embodiment, the center (442) of key 438 is located a greater relief distance from the hypothetical flat surface 432 than the center (444) of key 440 by a specific difference 446. The specific difference 446 between the two adjacent keys may be between 0.5 millimeters-5.0 millimeters.

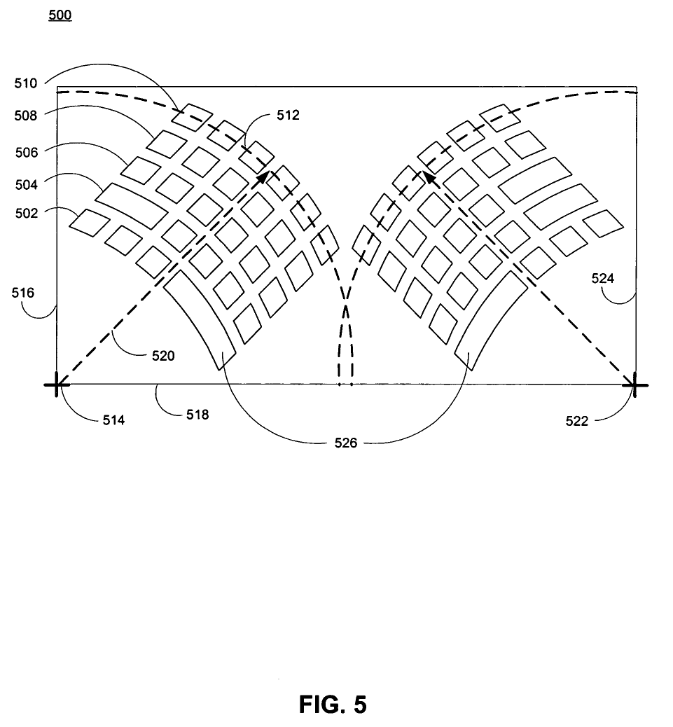

FIG. 5 illustrates another embodiment of a curved keyboard for the device. In this embodiment, the keyboard 500 is separated into two portions (i.e., halves), the left portion and the right portion. The left portion has multiple rows of keys, specifically row 1 (502), row 2 (504), row 3 (506), row 4 (508), and row 5 (510). Each of the five rows curves generally in an arc 512 around a left position 514 that is approximately at the intersection of the left edge of the device 516 and the bottom edge of the device 518. Row 5 (510), the furthest row away from the left position 514 has an arc radius length approximately equal to the distance between a point on the arc 512 of row 5 (510) and the left position. In one embodiment, all rows have the same arc radius length. Thus, in this embodiment, the center point of the arc of rows 1-4 would be off of the edge of the device. In another embodiment, all rows have the same center point (i.e., the left position 514). In this embodiment, the rows closer to the left position have a sharper curved arc.

In one embodiment, row 1 (502) is a uniform distance of positive relief above a hypothetical plane that extends from the left edge of the device 516 to the right edge of the device 524. In different embodiments, the amount of positive relief row 1 (502) extends above the plane is a distance between 0.5 millimeters and 5.0 millimeters. Additionally, in one embodiment, the difference in the amount of positive relief between each of the five rows is uniform. Thus, if the difference in the amount of positive relief between rows 1 and 2 is 5.0 millimeters, then that is the difference in the amount of positive relief between every adjacent row (i.e., between rows 2 and 3, between rows 3 and 4, etc.). In this embodiment, the positive relief that row 1 (502) extends above the hypothetical plane is the least of the five rows and the amount of positive relief that row 5 (510) extends above the hypothetical plane is the greatest of the five rows. In different embodiments, the difference in the amount of positive relief between two adjacent rows is between 0.5 millimeters and 5.0 millimeters.

In many embodiments, the right portion is a mirror image of the left portion. Thus, each of the five rows on the right portion of the keyboard also curve generally in an arc around a right position 522 that is approximately at the intersection of the right edge of the device 524 and the bottom edge of the device 518. Additionally, the same relative positions and distances apply to each row and its arc radius as described above regarding the left portion. In one embodiment, a user may place his or her hands in a location to take advantage of efficient thumb typing with a two-portion keyboard. In this embodiment, the user may place his or her left hand so the left thumb base joint is proximately in the location of the left position and the user may place his or her right hand so the right thumb base joint is proximately in the location of the right position. In this position, the user can pivot his or her left and right thumbs to reach any key respectively on the left and right portions of the keyboard. Additionally, the space bar key 526 is split into two separate keys, each of which is in the relative location of the space bar for each hand. This allows either hand to utilize the space bar key 526 for convenience.

Thus, embodiments of a mobile computing device form factor are disclosed. These embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A handheld computing device, comprising:
a display screen having a first side and a second side, the first side operable to display visual images;
a control mechanism coupled to the second side of the display screen, the control mechanism operable to control a visual indicia on the display screen.

2. The device of claim 1, further comprising a housing coupled to the second side of the display screen.

3. The device of claim 2, further comprising a keyboard having a front side and a back side, the front side of the keyboard having keys operable to input keystroke data.

4. The device of claim 3, wherein the housing is coupled to the back side of the keyboard.

5. The device of claim 1, wherein the control mechanism further comprises a capacitance-sensitive touch pad.

6. The device of claim 1, wherein the control mechanism further comprises a motion-sensitive optical pad.

7. The device of claim 1, wherein the control mechanism further comprises a pressure-sensitive joystick.

8. The device of claim 1, wherein the control mechanism further comprises a trackball.

9. The device of claim 1, wherein the control mechanism further comprises a scroll wheel.

10. The device of claim 1, further comprising one or more buttons, coupled to the housing, operable to provide input for control of the visual indicia.

11. A handheld computing device, comprising:
a display screen having a first side, a second side, and at least four edges, the first side operable to display visual images;
a housing having a first side and a second side, the first side of the housing coupled to the second side of the display screen at least at locations proximate to all four edges, wherein the second side of the display screen is covered by the housing; and
a control mechanism coupled to the second side of the housing, the control mechanism operable to control a visual indicia on the display screen.

12. The device of claim 11, wherein the first side of the housing faces in substantially the opposite direction of the second side of the housing.

13. The device of claim 12, further comprising one or more buttons, coupled to the second side of the housing, operable to provide input for control of the visual indicia.

14. The device of claim 13, wherein each of the one or more buttons further comprises a pressure-sensitive mechanical input to control a switch.

15. The device of claim 13, wherein each of the one or more buttons further comprises a light-sensitive optical input to control a switch.

16. The device of claim 13, wherein each of the one or more buttons further comprises a capacitance-sensitive conductive pad input to control a switch.

17. The device of claim 12, wherein the control mechanism further comprises a capacitance-sensitive touch pad.

18. The device of claim 12, wherein the control mechanism further comprises a motion-sensitive optical pad.

19. The device of claim 12, wherein the control mechanism further comprises a pressure-sensitive joystick.

20. The device of claim 12, wherein the control mechanism further comprises a trackball.

21. The device of claim 12, wherein the control mechanism further comprises a scroll wheel.

22. The device of claim 13, wherein the second side of the housing further comprises:
at least a left, right, top, and bottom edge; and
a surface defined at least in part by the left, right, top, and bottom edge, comprising:
a first portion of the surface protruding outward, the first portion located in an area of the surface substantially adjacent to the center of the top edge and extending down to the center of the surface;
a second portion of the surface protruding outward, the second portion located in an area of the surface between the center of the left side of the surface and the center of the surface; and
a third portion of the surface protruding outward, the third portion located in an area of the surface between the center of the right side of the surface and the center of the surface.

23. The device of claim 22, wherein the control mechanism is coupled to second side of the housing at substantially the center of the first portion of the surface.

24. The device of claim 23, further comprising:
a first button coupled to the second side of the housing at a location on the second portion of the surface that faces substantially toward an intersection of the left edge and the top edge, operable to provide input for control of the visual indicia; and
a second button coupled to the second side of the housing at a location on the third portion of the surface that faces substantially toward an intersection of the right edge and the top edge, operable to provide input for control of the visual indicia.

25. The device of claim 13, further comprising a keyboard having a plurality of keys arranged in a plurality of adjacent rows, the keyboard coupled to at least a portion of the first side of the housing.

26. The device of claim 25, wherein the first side of the housing has at least a bottom edge, the keyboard located in a position on the first side of the housing adjacent to at least a portion of the bottom edge.

27. The device of claim 26, further comprising each row of keys arranged in an arc curving away from a hypothetical tangential line intersecting the center of the arc.

28. The device of claim 27, wherein each key further comprises a depressible surface having at least a bottom edge, the bottom edge of the one or two keys located at the center of each row being the location where the hypothetical tangential line connects with the center of the arc, the distance incrementally increasing between the bottom edge of each adjacent key further left and right of the one or two center keys of the arc and the hypothetical tangential line, the distance being the greatest between the bottom edge of each row's left and right end keys and the hypothetical tangential line.

29. The device of claim 28, wherein the difference in the distance between the bottom edge of the depressible surface of a key and the hypothetical tangential line and the distance between the center of the depressible surface of an adjacent key located further from the center of the row is uniform, the difference being between 1.0 millimeters and 1.0 centimeters.

30. The device of claim 25, wherein each key further comprises a depressible surface with a positive relief from the surface of the first side of the housing, the positive relief being greatest for the one or two keys located at the center of each row, the positive relief incrementally decreasing for each key further left and right of the center of the row, the positive relief being the least for the left and right end keys of each row.

31. The device of claim 30, wherein the positive relief of the end keys of every row is uniform, the positive relief being between 0.5 millimeters and 5.0 millimeters.

32. The device of claim 31, wherein the increasing amount of positive relief of each adjacent key located closer to the center of each row is uniform, the increasing amount of positive relief being between 0.5 millimeters and 5.0 millimeters.

33. The device of claim 25, wherein the portion of the first side of the housing coupled to the keyboard further comprises:
a left and right edge; and
a surface, located between the left and right edges, protruding outward from the device, the protruding surface having a positive relief from a hypothetical plane connecting the left and right edge, the protruding surface having the greatest relief at a center line halfway between the left and right edge, the protruding surface having a decreasing relief for every location on the surface further to the left and right of the center line, the protruding surface having the least relief in any location immediately adjacent to the left and right edge.

34. The device of claim 33, wherein each key further comprises a depressible surface with a positive relief from the protruding surface of the first side of the housing, the positive relief from the protruding surface being uniform for all keys.

35. The device of claim 34, wherein the positive relief is between 0.5 millimeters and 5.0 millimeters.

36. The device of claim 35, wherein the distance between the center of the depressible surface of the end keys of every row and the hypothetical plane is uniform, the distance being between 0.5 millimeters and 2.5 millimeters.

37. The device of claim 36, wherein the difference in the distance between the center of the depressible surface of a key and the hypothetical plane and the distance between the center of the depressible surface of an adjacent key located closer to the center of the row is uniform, the difference being between 0.5 millimeters and 2.5 millimeters.

38. The device of claim 34, wherein the depressible surface of each key is parallel with the protruding surface.

39. The device of claim 34, wherein the depressible surface of each key is parallel with the hypothetical plane.

40. The device of claim 12, further comprising a keyboard having a plurality of keys divided into a left portion and a right portion, wherein the left portion comprises a plurality of rows of keys, each row shaped in an arc curving around a left position located proximately at the intersection of the bottom edge and the left edge of the first side of the second housing, and wherein the right portion comprises a plurality of rows of keys, each row shaped in an arc curving around a right position located proximately at the intersection of the bottom edge and the right edge of the first side of the housing.

41. The device of claim 40, wherein a hypothetical arc passing through the center of the row of keys on the left portion of the keyboard the greatest distance from the left position has an arc radius length substantially equal to the length from a point on the arc to the left position, and wherein a hypothetical arc passing through the center of the row of keys on the right portion of the keyboard the greatest distance from the right position has an arc radius length substantially equal to the length from a point on the arc to the right position.

42. The device of claim 41, wherein the arc radius length is substantially equal for all rows of keys located in both the left and right portions of the keyboard.

43. The device of claim 42, wherein all keys in each row are a uniform positive relief from a hypothetical plane connecting the left and right edge of the first side of the housing.

44. The device of claim 43, wherein the positive relief of the row of keys closest to the left position on the left portion of the keyboard and the positive relief of the row of keys closest to the right position on the right portion of the keyboard is between 0.5 millimeters and 5.0 millimeters above the hypothetical plane connecting the left and right edge of the first side of the housing.

45. The device of claim 44, wherein the difference in positive relief between any one row of keys located on the left portion of the keyboard and an adjacent row of keys located on the left portion of the keyboard and the difference in positive relief between any one row of keys located on the right portion of the keyboard and an adjacent row of keys located on the right portion of the keyboard is between 0.5 millimeters and 5.0 millimeters.

46. The device of claim 40, wherein the space bar key at the bottom center of the keyboard is split into two keys, allowing the space bar key to be depressed by a finger located proximately to either the left portion or right portion of the keyboard.

47. A handheld computing device, comprising:
a display screen having a first side, a second side, and at least four edges, the first side operable to display visual images;
a first housing having a first side and a second side, the first side of the first housing coupled to the second side of the display screen at least at locations proximate to all four edges, wherein the second side of the display screen is covered by the housing;
a second housing, coupled to the first housing, having at least a first side and a second side;
a keyboard coupled to the first side of the second housing;
a control mechanism, coupled to the second side of the second housing, operable to control a visual indicia on the display screen.

48. The device of claim 47, wherein the first side of the second housing faces in substantially the opposite direction of the second side of the second housing.

49. The device of claim 48, further comprising one or more buttons, coupled to the second side of the second housing, operable to provide input for control of the visual indicia.

50. The device of claim 49, wherein each of the one or more buttons further comprises a pressure-sensitive mechanical input to control a switch.

51. The device of claim 49, wherein each of the one or more buttons further comprises a light-sensitive optical input to control a switch.

52. The device of claim 49, wherein each of the one or more buttons further comprises a capacitance-sensitive touch pad input to control a switch.

53. The device of claim 48, wherein the control mechanism further comprises a capacitance-sensitive touch pad.

54. The device of claim 48, wherein the control mechanism further comprises a pressure-sensitive touch pad.

55. The device of claim 48, wherein the control mechanism further comprises a motion-sensitive optical pad.

56. The device of claim 48, wherein the control mechanism further comprises a pressure-sensitive joystick.

57. The device of claim 48, wherein the control mechanism further comprises a trackball.

58. The device of claim 48, wherein the control mechanism further comprises a scroll wheel.

59. The device of claim 49, wherein the second side of the second housing further comprises:
at least a left, right, top, and bottom edge; and
a surface defined at least in part by the left, right, top, and bottom edge, comprising:
a first portion of the surface protruding outward, the first portion located in an area of the surface substantially adjacent to the center of the top edge and extending down to the center of the surface;
a second portion of the surface protruding outward, the second portion located in an area of the surface between the center of the left side of the surface and the center of the surface; and
a third portion of the surface protruding outward, the third portion located in an area of the surface between the center of the right side of the surface and the center of the surface.

60. The device of claim 59, wherein the control mechanism is coupled to second side of the second housing at substantially the center of the first portion of the surface.

61. The device of claim 60, further comprising:
a first button coupled to the second side of the housing at a location on the second portion of the surface that faces substantially toward an intersection of the left edge and the top edge, operable to provide input for control of the visual indicia; and
a second button coupled to the second side of the housing at a location on the third portion of the surface that faces substantially toward an intersection of the right edge and the top edge, operable to provide input for control of the visual indicia.

62. The device of claim 49, further comprising a keyboard having a plurality of keys arranged in a plurality of adjacent rows, the keyboard coupled to at least a portion of the first side of the housing.

63. The device of claim 62, wherein the first side of the housing has at least a bottom edge, the keyboard located in a position on the first side of the housing adjacent to at least a portion of the bottom edge.

64. The device of claim 63, further comprising each row of keys arranged in an arc curving away from a hypothetical tangential line intersecting the center of the arc.

65. The device of claim 64, wherein each key further comprises a depressible surface having at least a bottom edge, the bottom edge of the one or two keys located at the center of each row being the location where the hypothetical tangential line connects with the center of the arc, the distance incrementally increasing between the bottom edge of each adjacent key further left and right of the one or two center keys of the arc and the hypothetical tangential line, the distance being the greatest between the bottom edge of each row's left and right end keys and the hypothetical tangential line.

66. The device of claim 65, wherein the difference in the distance between the bottom edge of the depressible surface of a key and the hypothetical tangential line and the distance between the center of the depressible surface of an adjacent key located further from the center of the row is uniform, the difference being between 1.0 millimeters and 1.0 centimeters.

67. The device of claim 62, wherein each key further comprises a depressible surface with a positive relief from the surface of the first side of the housing, the positive relief being greatest for the one or two keys located at the center of each row, the positive relief incrementally decreasing for each key further left and right of the center of the row, the positive relief being the least for the left and right end keys of each row.

68. The device of claim 67, wherein the positive relief of the end keys of every row is uniform, the positive relief being between 0.5 millimeters and 5.0 millimeters.

69. The device of claim 68, wherein the increasing amount of positive relief of each adjacent key located closer to the center of each row is uniform, the increasing amount of positive relief being between 0.5 millimeters and 2.5 millimeters.

70. The device of claim 62, wherein the portion of the first side of the housing coupled to the keyboard further comprises:
a left and right edge; and
a surface, located between the left and right edges, protruding outward from the device, the protruding surface having a positive relief from a hypothetical plane connecting the left and right edge, the protruding surface having the greatest relief at a center line halfway between the left and right edge, the protruding surface having a decreasing relief for every location on the surface further to the left and right of the center line, the protruding surface having the least relief in any location immediately adjacent to the left and right edge.

71. The device of claim 70, wherein each key further comprises a depressible surface with a positive relief from the protruding surface of the first side of the housing, the positive relief from the protruding surface being uniform for all keys.

72. The device of claim 71, wherein the positive relief is between 0.5 millimeters and 5.0 millimeters.

73. The device of claim 72, wherein the distance between the center of the depressible surface of the end keys of every row and the hypothetical plane is uniform, the distance being between 0.5 millimeters and 2.5 millimeters.

74. The device of claim 73, wherein the difference in the distance between the center of the depressible surface of a key and the hypothetical plane and the distance between the center of the depressible surface of an adjacent key located closer to the center of the row is uniform, the difference being between 0.55 millimeters and 5.0 millimeters.

75. The device of claim 71, wherein the depressible surface of each key is parallel with the protruding surface.

76. The device of claim 71, wherein the depressible surface of each key is parallel with the hypothetical plane.

77. The device of claim 48, further comprising a keyboard having a plurality of keys divided into a left portion and a right portion, wherein the left portion comprises a plurality of rows of keys, each row shaped in an arc curving around a left position located proximately at the intersection of the bottom edge and the left edge of the first side of the second housing, and wherein the right portion comprises a plurality of rows of keys, each row shaped in an arc curving around a right position located proximately at the intersection of the bottom edge and the right edge of the first side of the second housing.

78. The device of claim 77, wherein a hypothetical arc passing through the center of the row of keys on the left portion of the keyboard the greatest distance from the left position has an arc radius length substantially equal to the length from a point on the arc to the left position, and wherein a hypothetical arc passing through the center of the row of keys on the right portion of the keyboard the greatest distance from the right position has an arc radius length substantially equal to the length from a point on the arc to the right position.

79. The device of claim 78, wherein the arc radius length is substantially equal for all rows of keys located in both the left and right portions of the keyboard.

80. The device of claim 79, wherein all keys in each row are a uniform positive relief from a hypothetical plane connecting the left and right edge of the first side of the second housing.

81. The device of claim 80, wherein the positive relief of the row of keys closest to the left position on the left portion of the keyboard and the positive relief of the row of keys closest to the right position on the right portion of the keyboard is between 0.5 millimeters and 5.0 millimeters above the hypothetical plane connecting the left and right edge of the first side of the second housing.

82. The device of claim 81, wherein the difference in positive relief between any one row of keys located on the left portion of the keyboard and an adjacent row of keys located on the left portion of the keyboard and the difference in positive relief between any one row of keys located on the right portion of the keyboard and an adjacent row of keys located on the right portion of the keyboard is between 0.5 millimeters and 5.0 millimeters.

83. The device of claim 77, wherein the space bar key at the bottom center of the keyboard is split into two keys, allowing the space bar key to be depressed by a finger located proximately to either the left portion or right portion of the keyboard.

84. The device of claim 48, further comprising:
the first and second housings each having at least a top and bottom edge;
a pivot hinge coupling the bottom edge of the first housing with the top edge of the second housing, the pivot hinge operable to allow the device to be in at least a fully closed position where the keyboard and display are not visible or in one of a plurality of fully open positions where the keyboard and display are visible, wherein the fully closed position situates substantially the entire first side of the first housing in close proximity with substantially the entire first side of the second housing, the top edge of the first housing proximate to the bottom edge of the second housing, and wherein each of the plurality of fully open positions situates only the pivot hinge coupled bottom edge of the first housing in close proximity with the pivot hinge coupled top edge of the second housing, the top edge of the first housing being substantially away from the bottom edge of the second housing.

85. The device of claim 84, further comprising an automated power switch operable to power the device on when the device is situated in any one of the plurality of fully open positions, and operable to power the device off when the device is situated in its fully closed position.

86. The device of claim 47, further comprising the first side of the second housing slidingly attached to the second side of the first housing.
